(19) United States
(12) Patent Application Publication
(10) Pub. No.: US 2006/0047376 A1
(43) Pub. Date: Mar. 2, 2006

(54) Interface apparatus for a vehicle audio/video application and method for the same

(75) Inventors: Yeou-Tsair Jiang, Taipei Hsien (TW); Shih-Nan Lu, Hsi Chih City (TW); Chia-Nan Huang, Miao Li Hsien (TW); Wen-Yen Chou, Taipei Hsien (TW)

Correspondence Address: TROXELL LAE OFFICE PLLC;SUITE 1404, 5205 LEESBURG PIKE, FALLS CHURCH, VA, 22041, US

(73) Assignee: BCOM ELECTRONICS INC.

(21) Appl. No.: 10/923,688

(22) Filed: Aug. 24, 2004

(51) Int. Cl. G05D 1/00

(52) U.S. Cl. 701/2

(57) ABSTRACT

An interface apparatus for a vehicle has a display, a man-machine controller connected to the display and an interface graphic generator. The man-machine controller generates a first control signal, a second control signal and an image signal, and sends the first control signal and the image signal to the display. The interface graphic generator is connected to the display and the man-machine controller and controlled by the second control signal to send an interface graphic to the display. The man-machine controller is operated under an operation procedure set for outputting the second control signal to the interface graphic generator, and the interface graphic generator generates and sends an interface graphic, corresponding to a specific operation procedure in the operation procedure set, to the display for displaying the interface graphic.

### BACKGROUND OF THE INVENTION

1. Field of the invention

The present invention relates to an interface apparatus for a vehicle audio/video application and method for the same, especially to an interface apparatus installed in a vehicle and connected to audio/video equipment in the vehicle for easy control by a user.

2. Description of Prior Art

With the rapid progress of consumer products and technology, the quality of life is also of concern to people. Vehicle drivers usually listen to audio equipment such as a tape player or a CD set in the vehicle. Thanks to the development of flat panel display, vehicle drivers also can enjoy video entertainment recorded on, for example, VCDs or DVDs.

However, the conventional audio/video equipment in the vehicle has only a simple and numeric human-machine interface. It is difficult for a user to know the operational status of the audio/video equipment in the vehicle and it is also dangerous for the driver to use.

### SUMMARY OF THE INVENTION

It is the object of the present invention to provide an interface apparatus installed in a vehicle and connected to peripheral equipment in the vehicle allowing a user easy control and use of audio and video equipment.

To achieve the above object, the present invention provides an interface apparatus for a vehicle including the following elements. A display is connected to a man-machine controller. The man-machine controller generates a first control signal, a second control signal and an image signal, and sends the first control signal and the image signal to the display. An interface graphic generator is connected to the display and the man-machine controller and controlled by the second control signal to send an interface graphic to the display.

The man-machine controller is operated under an operation procedure set for outputting the second control signal to the interface graphic generator, and the interface graphic generator generates and sends an interface graphic, corresponding to a specific operation procedure in the operation procedure set, to the display for displaying the interface graphic.

The interface apparatus for a vehicle further comprises at least one function key to select and execute the operational procedure.

The interface apparatus for a vehicle further comprises a memory card accessing unit connected to the interface graphic generator to read image data in the memory card and send the image data to the interface graphic generator.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth particularity in the appended claims. The invention itself however may be best understood by reference to the following detailed description of the invention, which describes certain exemplary embodiments of the invention, taken in conjunction with the accompanying drawings, in which:

FIG. 1 illustrates application of the present invention in a vehicle;

FIG. 2 is a block diagram of the present invention;

FIG. 3 illustrates an interface graphic according to the present invention;

FIG. 4 illustrates operation of the present invention;

FIGS. 5A-H illustrate chips used in the present invention; and

FIGS. 6A-D also illustrates chips used in the present invention.

### DETAILED DESCRIPTION OF THE INVENTION

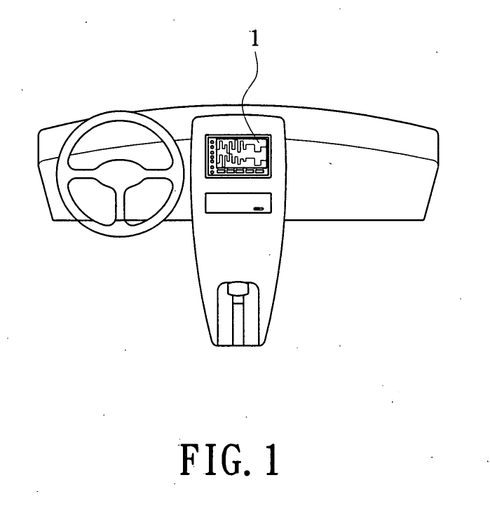

FIG. 1 shows the application of the present invention in a vehicle, wherein the interface apparatus 1 is arranged within the vehicle for easy operation by a car driver.

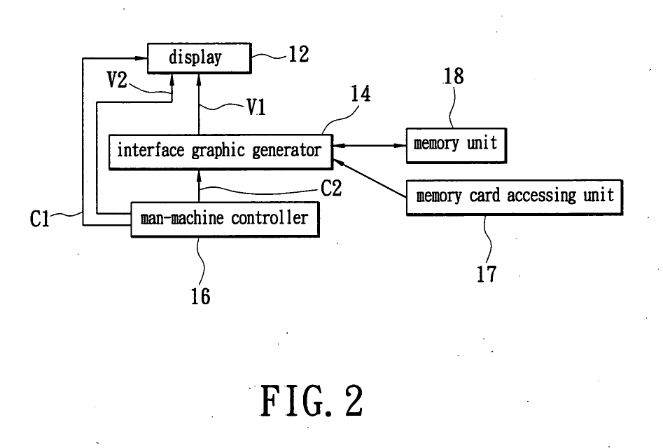

FIG. 2 shows the block diagram of the present invention. The interface apparatus 1 comprises a display 12, an interface graphic generator 14, a man-machine controller 16, a memory card accessing unit 17 and a memory unit 18.

As shown in FIG. 2, the man-machine controller 16 is connected between the display 12 and the interface graphic generator 14 and generates a first control signal C1, a second control signal C2 and an image signal V2. The man-machine controller 16 sends the first control signal Cl and the image signal V2 to the display 12, and sends the second control signal C2 to the interface graphic generator 14. The interface graphic generator 14 is connected between the display 12 and the memory unit 18 and is controlled by the second control signal C2 to access an interface graphic V1 stored in the memory unit 18. The interface graphic V1 is processed by the interface graphic generator 14 and then output to the display 12 for display.

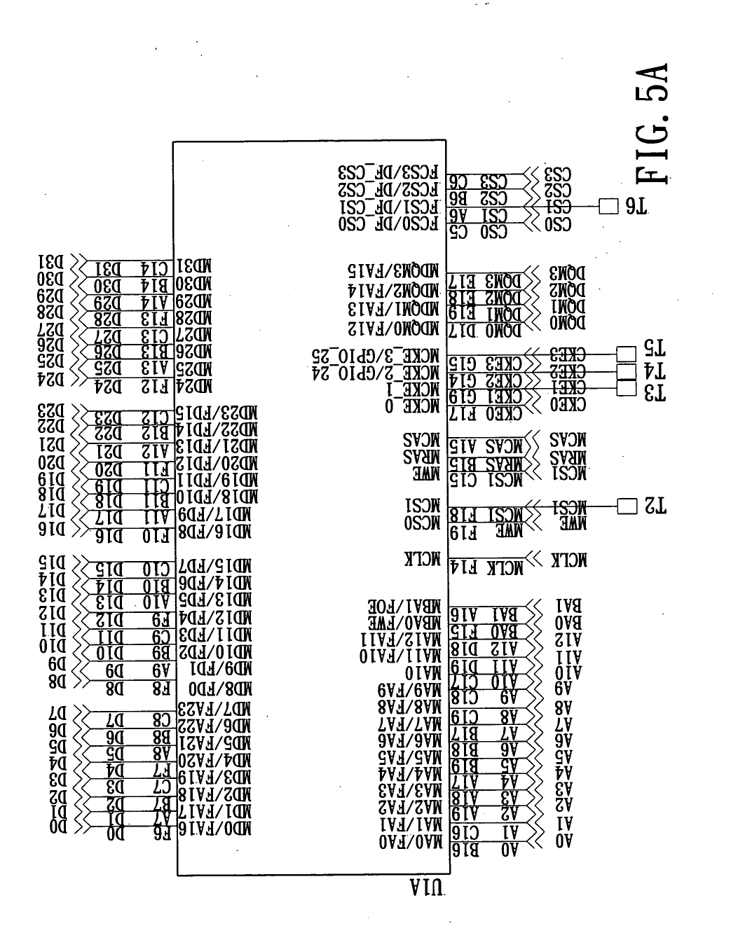

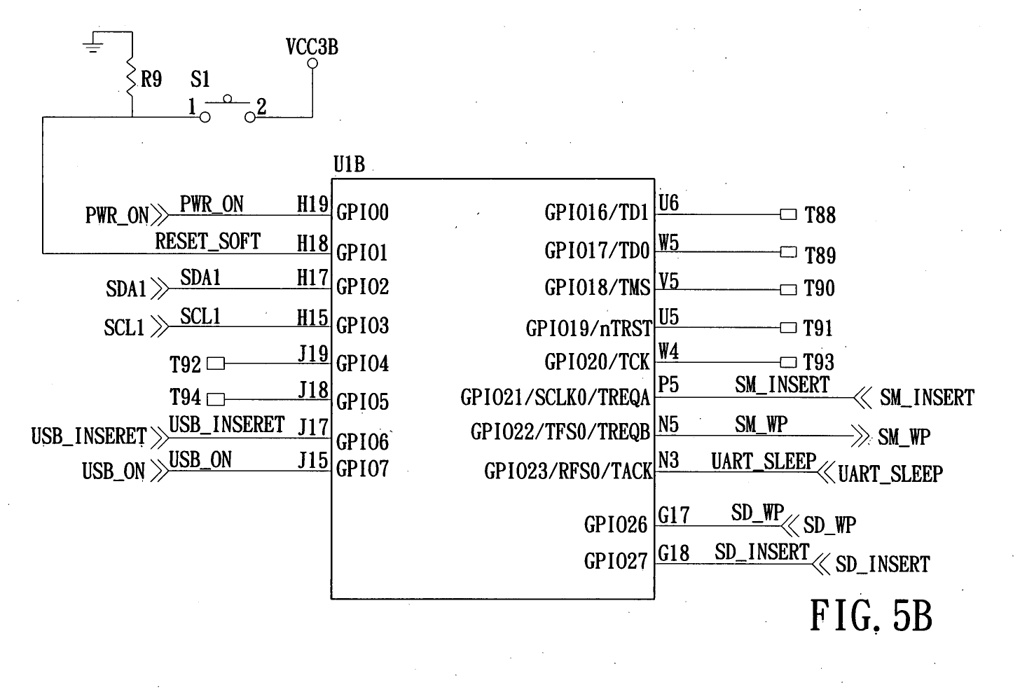

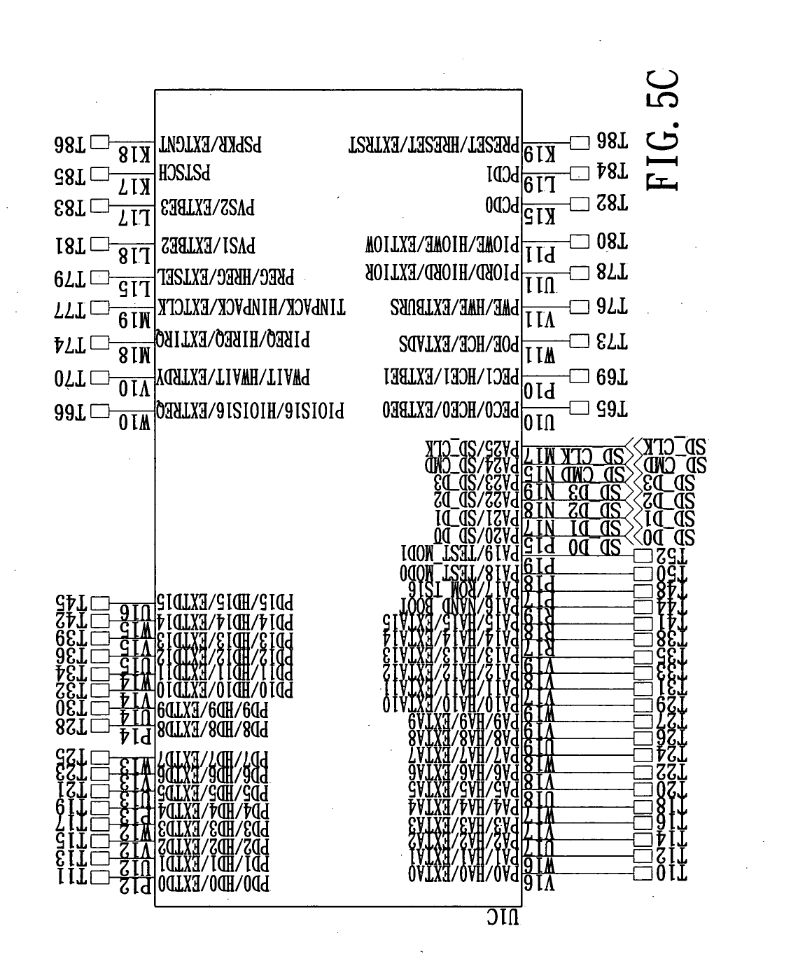

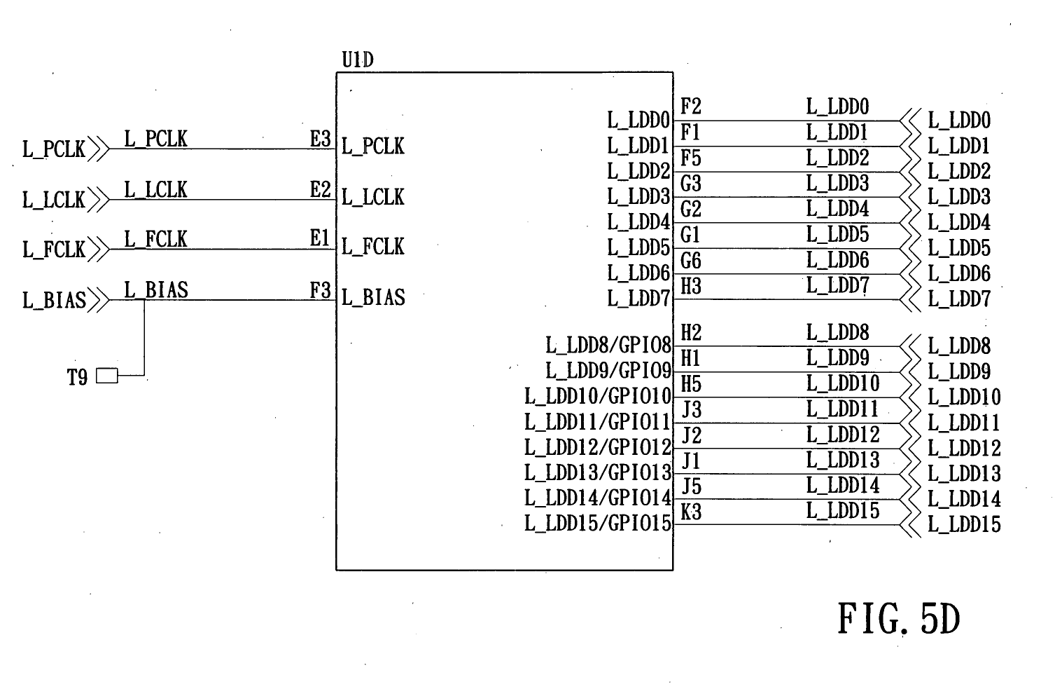

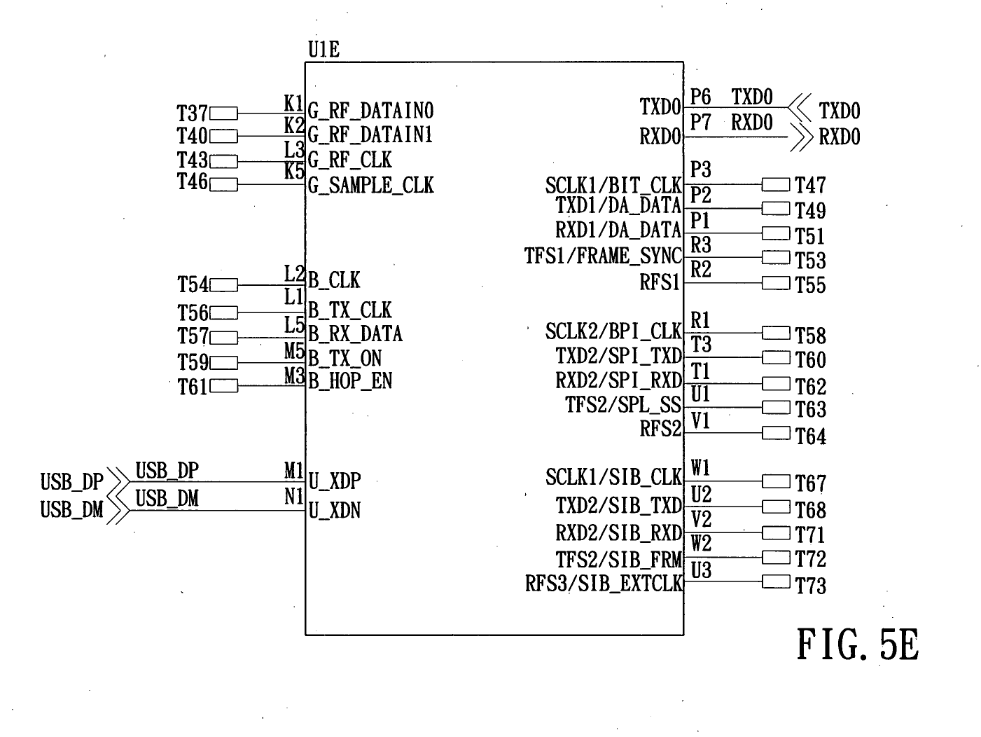

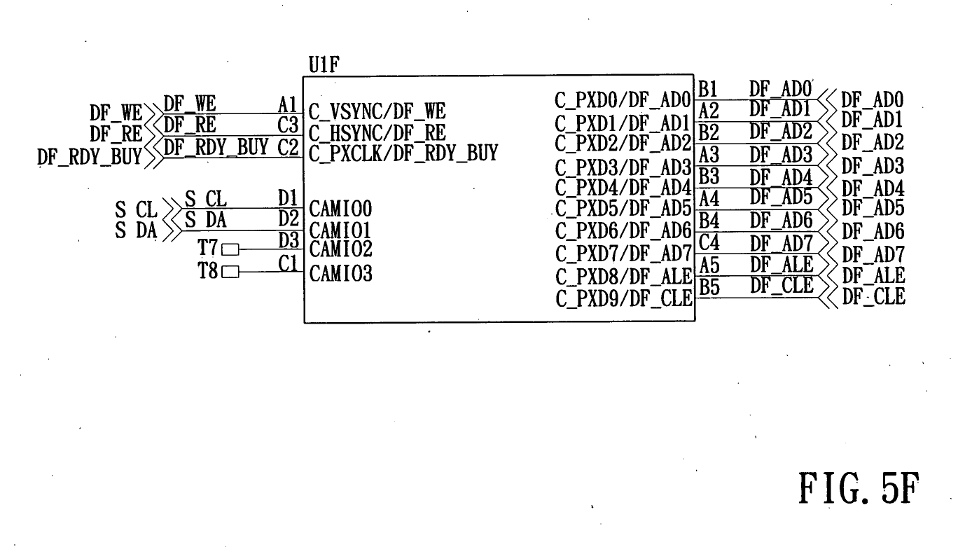

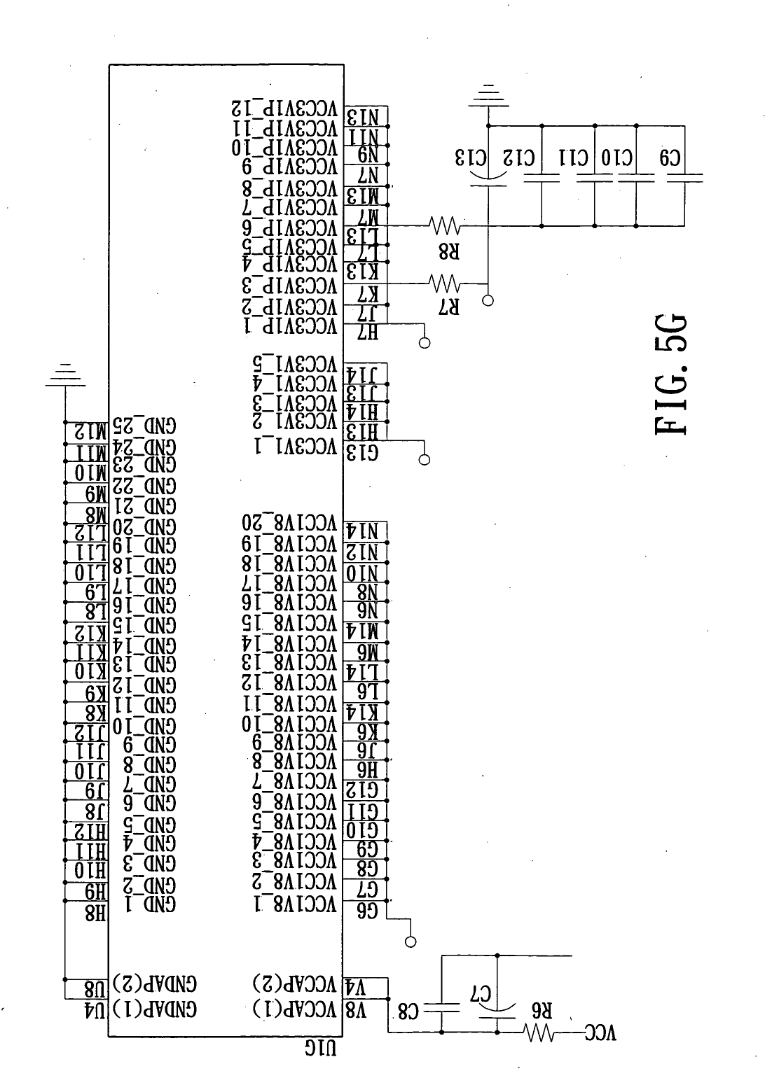

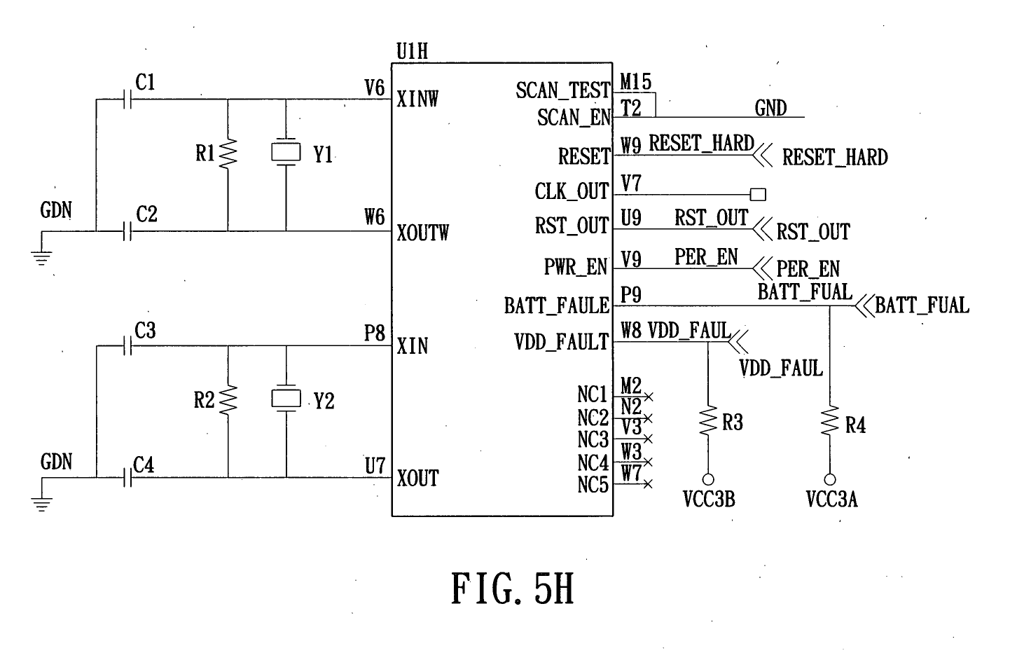

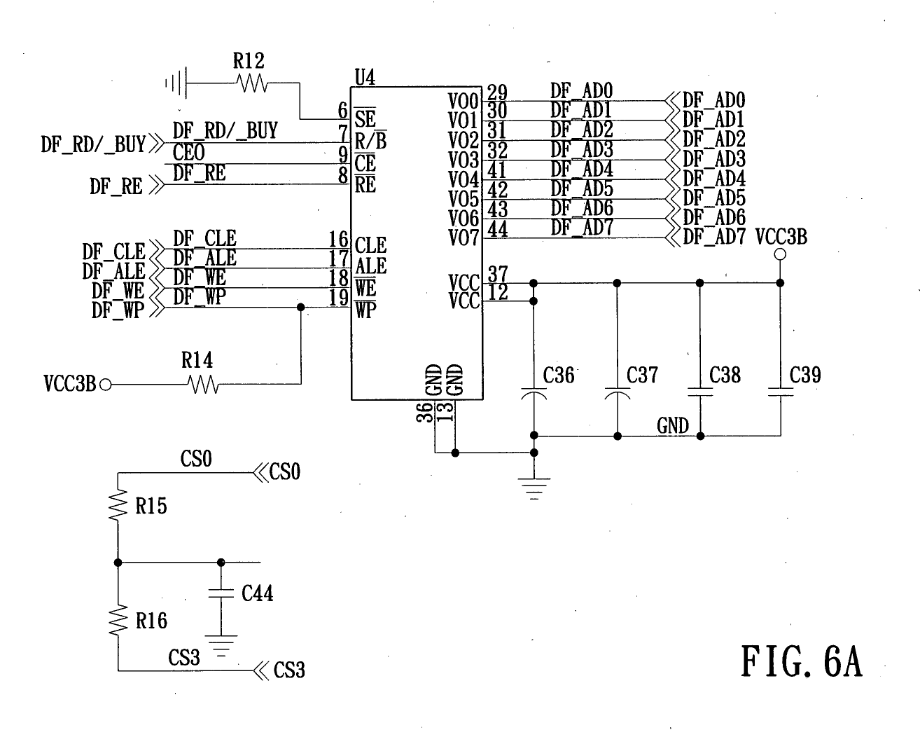

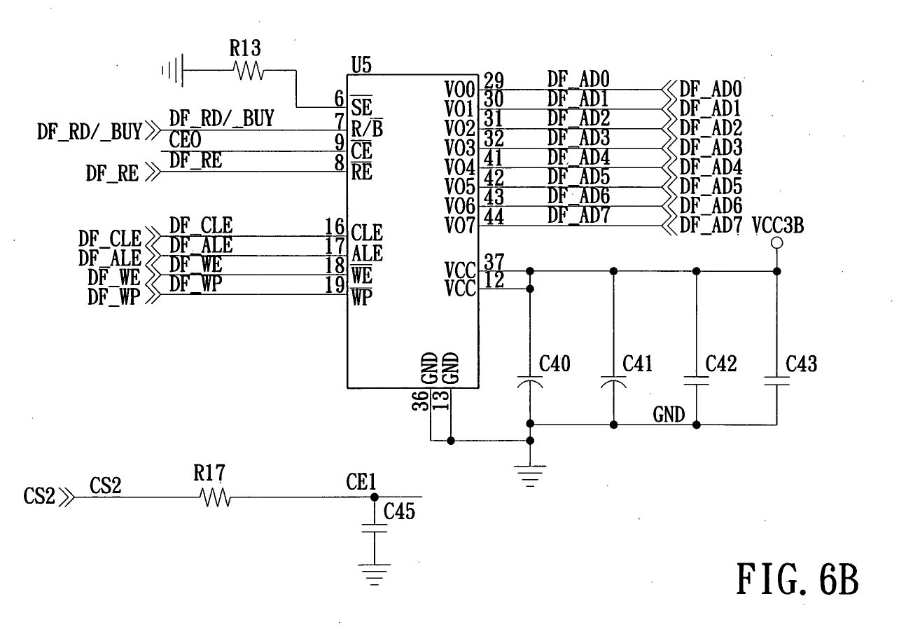

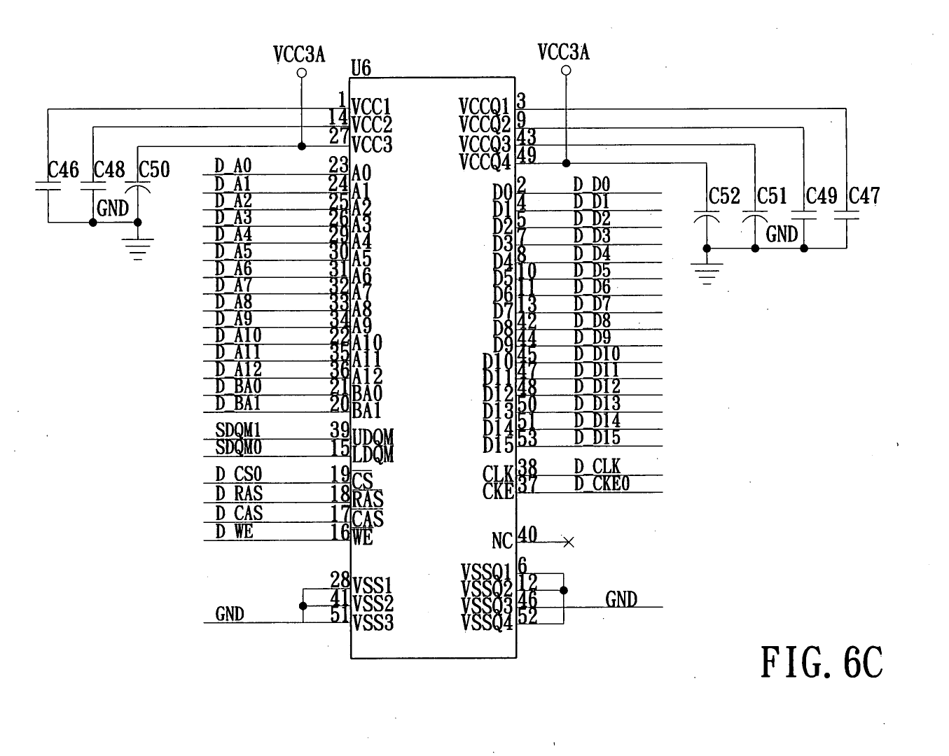

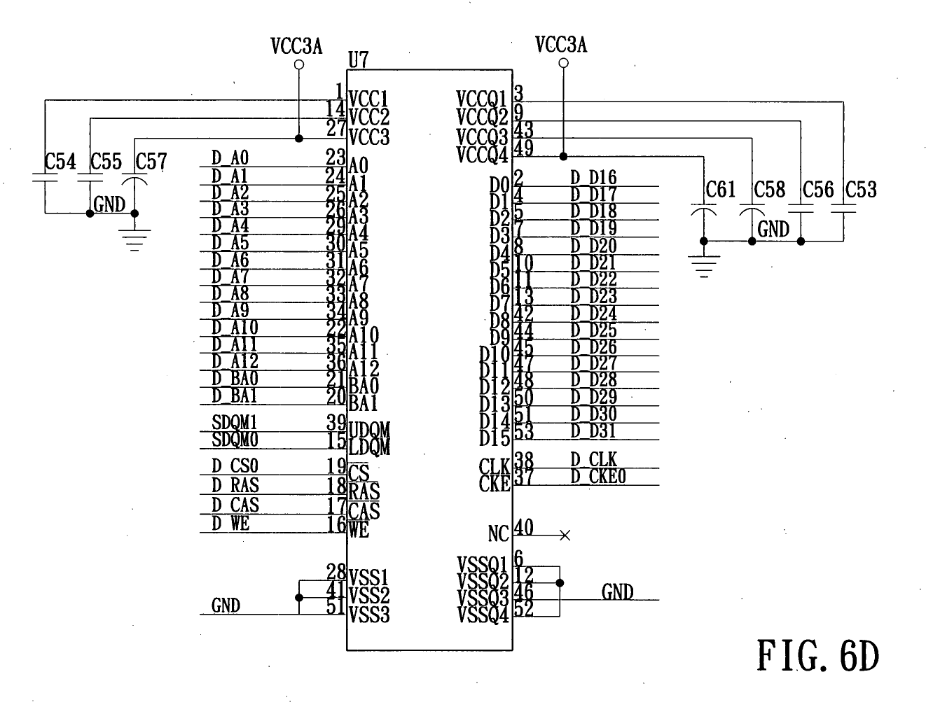

FIGS. 5A-H show chips used in the present invention, where the chips UIA-UIH are used for the interface graphic generator 14 for processing graphic data. Moreover, FIGS. 6A-D also show chips used in the present invention, where the chips U4 to U7 are used for the memory unit 18 for storing graphic data and control command.

In above description, the memory card accessing unit 17 is connected to the interface graphic generator 14. The user can insert a detachable memory card (not shown) into the memory card accessing unit 17 and the memory card accessing unit 17 sends digital video data to the interface graphic generator 14. The digital video data processed by the interface graphic generator 14 is then sent to the display 12 for display.

With reference also to FIG. 2, the man-machine controller 16 is operated by an operational procedure set and sends the second control signal C2 to the interface graphic generator 14. The interface graphic generator 14 is also operated under this operational procedure set and provides the interface graphic V1 to the display 12 for display. In above description, the interface graphic generator 14 is controlled by the man-machine controller 16 to access the interface graphic V1 from the memory unit 18. Moreover, the interface graphic generator 14 reads a digital video (image) data from the memory card in the memory card accessing unit 17 and sends the digital video (image) data to the display 12 for display.

In above description, the operational procedure set for controlling the man-machine controller 16 includes a voice control procedure, a wireless FM/AM procedure, a time procedure, a screen-adjusting procedure, an MP3 playing procedure, a CD playing procedure, a VCD playing procedure, and a DVD playing procedure.

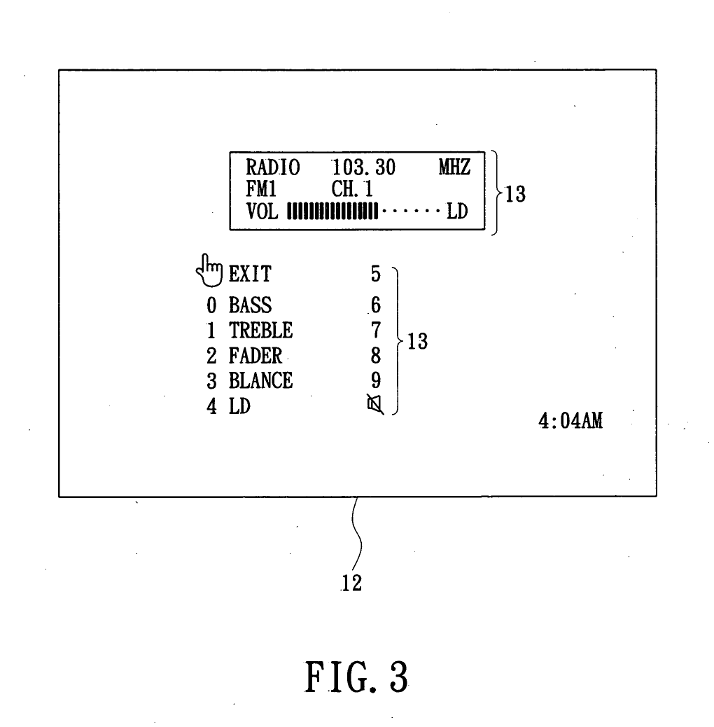

FIG. 3 illustrates an interface graphic according to the present invention, where the display 12 shows the operation status for the operational procedure set. As shown in FIG. 3, an interface graphic 13 corresponding to the operational procedure is displayed.

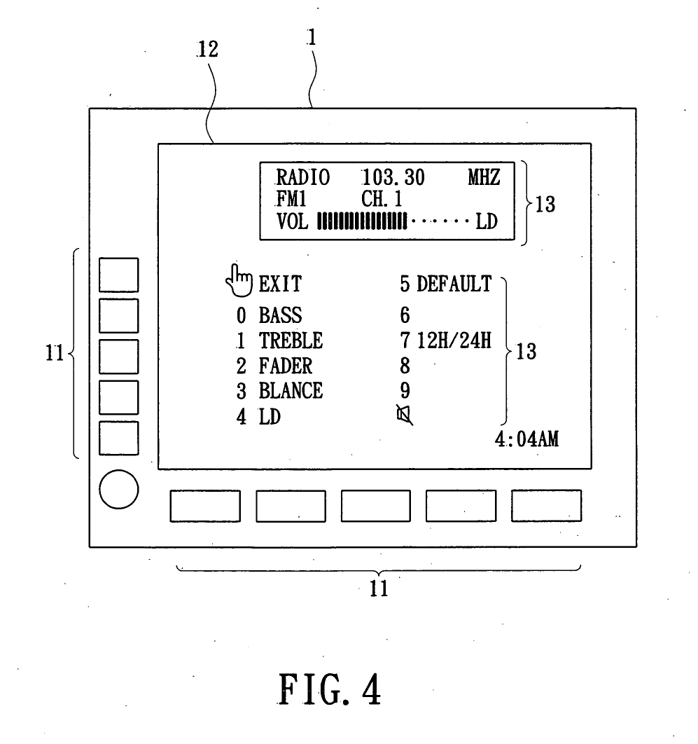

FIG. 4 illustrates operation of the present invention. The interface apparatus 1 of the present invention has at least one function key 11 to select the operational procedure and the display 12 shows corresponding interface graphic 13 for the particular operational procedure. In the above description, the function key 11 and the display 12 can be replaced by a touch-screen display.

With reference to FIG. 2, the man-machine controller 16 is operated under the operational procedure and outputs the image signal V2 to the display 12, where the operational procedure corresponds to the VCD playing procedure and the DVD playing procedure.

With reference again to FIG. 2, the man-machine controller 16 is operated under the operational procedure and outputs the first control signal C1 to the display 12, where the operational procedure corresponds to the screen-adjusting procedure.

In summary, the man-machine controller 16 according to the present invention is operated under the operational procedure to produce the second control signal C2 to the graphic generator 14 and controls the graphic generator 14 according to the operational procedure. Therefore, the interface graphic V1 corresponding to the operational procedure is sent to the display 12 for displaying the interface graphic V1.

Moreover, the interface apparatus 1 of the present invention has at least one function key 11 to select and operate the operational procedure. The function key 11 and the display 12 can be replaced by a touch-screen display. The interface apparatus 1 of the present invention uses the memory card accessing unit 17 to read digital video (image) data from the memory card and displays the digital video (image) data on the display 12.

FIG. 7 shows a flowchart of the interface method for vehicle audio/video application according to the present invention. In step S100, a function key is operated to select an operation procedure. In step S102, a man-machine controller is used to execute the operation procedure. In step S104: The man-machine controller outputs a control signal to an interface graphic generator. In step S106, the interface graphic generator outputs an interface graphic corresponding to the operation. In step S108, the interface graphic is displayed simultaneously by a display.

Therefore, the interface apparatus 1 of the present invention can provide an attractive operational interface. The operational interface can use image or icon to show the selection and execution of a procedure. Therefore, the driver can easily identify an operation status during driving. The interface apparatus 1 of the present invention can be used with other facilities in a vehicle to provide attractive audio/video amusement for a driver.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An interface apparatus for a vehicle, comprising
a display;
a man-machine controller connected to the display, generating a first control signal, a second control signal and an image signal, and sending the first control signal and the image signal to the display; and
an interface graphic generator connected to the display and the man-machine controller and controlled by the second control signal to send an interface graphic to the display;
wherein the man-machine controller is operated under an operation procedure set for outputting the second control signal to the interface graphic generator, and the interface graphic generator generates and sends an interface graphic, corresponding to a specific operation procedure in the operation procedure set, to the display for displaying the interface graphic.

2. The interface apparatus for a vehicle as in claim 1, further comprising a memory unit connected to the interface graphic generator to store the interface graphic.

3. The interface apparatus for a vehicle as in claim 1, further comprising a memory card accessing unit connected to the interface graphic generator to read image data in a memory card and send the image data to the interface graphic generator.

4. The interface apparatus for a vehicle as in claim 1, wherein the operation procedure set comprises a voice control procedure, a wireless FM/AM procedure, a time procedure, a screen-adjusting procedure, an MP3 playing procedure, a CD playing procedure, a VCD playing procedure, and a DVD playing procedure.

5. The interface apparatus for a vehicle as in claim 1, further comprising at least one function key to select and execute the operational procedure.

6. The interface apparatus for a vehicle as in claim 1, wherein the display shows an operation status of the operation procedure.

7. The interface apparatus for a vehicle as in claim 1, wherein the image signal is generated when the man-machine controller processes the operation procedure.

8. The interface apparatus for a vehicle as in claim 7, wherein the operation procedure is a VCD playing procedure or a DVD playing procedure.

9. The interface apparatus for a vehicle as in claim 1, wherein the first control signal is generated when the man-machine controller processes the operation procedure.

10. The interface apparatus for a vehicle as in claim 9, wherein the operation procedure is a screen-adjusting procedure.

11. The interface apparatus for a vehicle as in claim 7, wherein a function key and the display are replaced by a touch-screen display.

12. An interface method for vehicle audio/video application, comprising the steps of:
using a function key to select an operation procedure from an operation procedure set;
using a man-machine controller to execute the operation procedure;
outputting a control signal to an interface graphic generator from the man-machine controller;
outputting an interface graphic corresponding to the operation procedure from the interface graphic generator; and
displaying the interface graphic by a display.

13. The interface method for vehicle audio/video application as in claim 12, wherein the operation procedure set comprises a voice control procedure, a wireless FM/AM procedure, a time procedure, a screen-adjusting procedure, an MP3 playing procedure, a CD playing procedure, a VCD playing procedure, and a DVD playing procedure.
